(19) United States
(12) Patent Application Publication
(10) Pub. No.: US 2018/0024793 A1
(43) Pub. Date: Jan. 25, 2018

(54) IMAGE PROCESSING APPARATUS, NON-TRANSITORY COMPUTER READABLE MEDIUM, AND IMAGE PROCESSING METHOD

(71) Applicant: FUJI XEROX CO., LTD., Tokyo (JP)

(72) Inventors: Kenji NOMURA, Kanagawa (JP); Takeshi ICHIMURA, Kanagawa (JP); Kenji KOGURE, Kanagawa (JP); Nobuyuki OBAYASHI, Kanagawa (JP); Masaki KUROKAWA, Kanagawa (JP)

(73) Assignee: FUJI XEROX CO., LTD., Tokyo (JP)

(21) Appl. No.: 15/445,591

(22) Filed: Feb. 28, 2017

(30) Foreign Application Priority Data
Jul. 25, 2016 (JP) 2016-145564

(51) Int. Cl. G06F 3/12; H04N 1/00

(52) U.S. Cl. CPC G06F 3/1238; G06F 3/1222; H04N 1/00411; H04N 2201/0094

(57) ABSTRACT

An image processing apparatus includes an authenticating unit that performs authentication as to whether a user is an authenticated user who is permitted to use multiple functions, a determining unit that, by use of history information that records an operation made by the authenticated user authenticated by the authenticating unit, determines an expected function that is expected to be executed by the authenticated user among the multiple functions, and a setting attribute for each of setting items that specify how the expected function is to be executed, a setting unit that sets the setting attribute for the expected function determined by the determining unit, and a display that displays, on a display device, an execution screen that shows the setting attribute set by the setting unit and receives an instruction instructing that the expected function be executed.

### CROSS-REFERENCE TO RELATED APPLICATIONS

This application is based on and claims priority under 35 USC 119 from Japanese Patent Application No. 2016-145564 filed Jul. 25, 2016.

### BACKGROUND

### Technical Field

The present invention relates to an image processing apparatus, a non-transitory computer readable medium, and an image processing method.

### SUMMARY

According to an aspect of the invention, there is provided an image processing apparatus including an authenticating unit that performs authentication as to whether a user is an authenticated user who is permitted to use multiple functions, a determining unit that, by use of history information that records an operation made by the authenticated user authenticated by the authenticating unit, determines an expected function that is expected to be executed by the authenticated user among the multiple functions, and a setting attribute for each of setting items that specify how the expected function is to be executed, a setting unit that sets the setting attribute for the expected function determined by the determining unit, and a display that displays, on a display device, an execution screen that shows the setting attribute set by the setting unit and receives an instruction instructing that the expected function be executed.

### BRIEF DESCRIPTION OF THE DRAWINGS

Exemplary embodiments of the present invention will be described in detail based on the following figures, wherein:

FIG. 1 illustrates an example of an image processing system;

FIG. 2 is a perspective view of the major portion of an example of an image processing apparatus;

FIG. 3 illustrates an exemplary functional configuration of an image processing apparatus;

FIG. 4 illustrates an example of setting items and setting attributes that are associated with a scanner function;

FIG. 5 illustrates an example of setting items and setting attributes that are associated with a print function;

FIG. 6 illustrates an example of setting items and setting attributes that are associated with a FAX function;

FIG. 7 illustrates an example of setting items and setting attributes that are associated with a copy function;

FIG. 8 illustrates an example of screen transitions in an image processing apparatus;

FIG. 9 illustrates an example of the data structure of history information;

FIG. 10 illustrates an exemplary configuration of the major portion of the electrical system of an image processing apparatus;

FIG. 11 is a flowchart of an example of an operation support process according to a first exemplary embodiment;

FIG. 12 illustrates a first example of an execution screen;

FIG. 13 illustrates a second example of an execution screen;

FIG. 14 illustrates a third example of an execution screen;

FIG. 15 is a flowchart of an example of an operation support process according to a second exemplary embodiment;

FIG. 16 is a flowchart of an example of a pre-authentication-operation reference process; and

FIG. 17 is a flowchart of an example of an operation support process according to a third exemplary embodiment.

### DETAILED DESCRIPTION

Hereinafter, exemplary embodiments of the present invention will be described in detail with reference to the drawings. The same reference signs will be used throughout the drawings to designate components that are identical in operation or function to avoid repetitive description.

### First Exemplary Embodiment

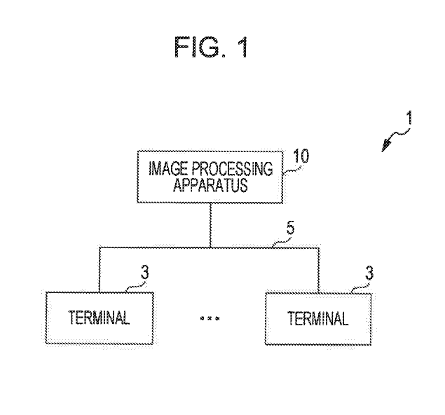

FIG. 1 illustrates an example of an image processing system 1. As illustrated in FIG. 1, in the image processing system 1, an image processing apparatus 10 that executes multiple predetermined functions related to an image, and multiple terminals 3 each used by a user are connected to each other via a communication line 5.

The user causes desired image processing to be executed by the image processing apparatus 10 by, for example, either transmitting image data generated by the terminal 3 to the image processing apparatus 10 via the communication line 5, or moving to the image processing apparatus 10 with the above-mentioned image data stored on a portable storage medium, such as a universal serial bus (USB) memory or a memory card, and connecting the portable storage medium to the image processing apparatus 10. Alternatively, the user causes desired image processing to be executed by the image processing apparatus 10 by moving to the image processing apparatus 10 while carrying a recording medium with an image formed thereon, such as paper, and inserting the recording medium into the image processing apparatus 10.

Further, in some cases, for example, the user receives image data that has undergone image processing in the image processing apparatus 10, on the terminal 3 via the communication line 5, or outputs the image data to a portable storage medium.

The manner in which communication is provided via the communication line 5 is not particularly limited. The communication line 5 may provide any one of a wired connection, a wireless connection, and a mixture of wired and wireless connections. The number of terminals 3 connected to the image processing apparatus 10 is not particularly limited, either. For example, the image processing apparatus 10 may be provided with no terminal 3.

The image processing apparatus 10 is preset to be usable by a predetermined user. A user enters a user name and a password that are uniquely associated with the user (to be referred to as “authentication information” hereinafter) to the image processing apparatus 10. The user is permitted to use the image processing apparatus 10 if authenticated to be a predetermined user. That is, the user is not permitted to use the image processing apparatus 10 if the user is not authenticated to be a predetermined user.

The user who has been authenticated to be a predetermined user by the image processing apparatus 10 will be specifically referred to as “authenticated user”. That is, users include authenticated users who have been authenticated by the image processing apparatus 10, and users who have not been authenticated by the image processing apparatus 10.

The following description will be directed to a case in which the image processing apparatus 10 is connected with multiple terminals 3 via the communication line 5, with the image processing apparatus 10 used by multiple users in a shared manner.

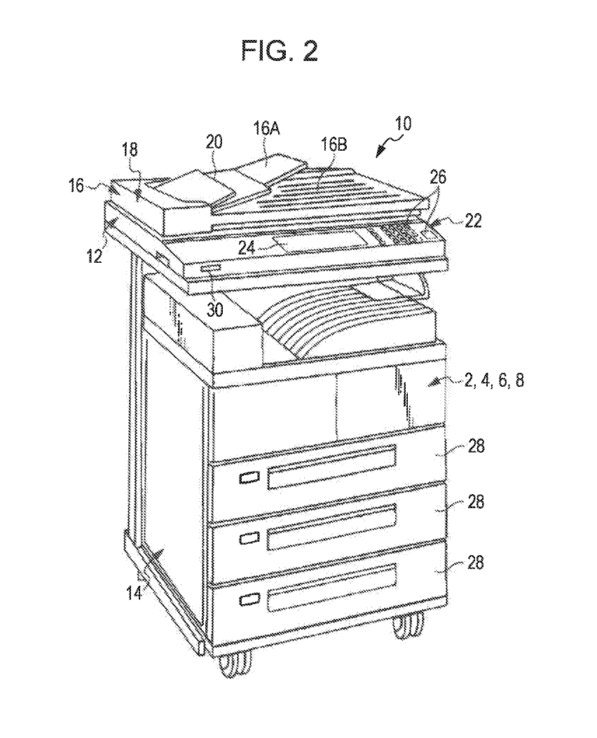

FIG. 2 is a perspective view of the major portion of the image processing apparatus 10. In one example, the image processing apparatus 10 has the following functions: a scanner function that reads, as image data, an image formed on a recording medium such as paper, a print function that forms an image corresponding to image data on a recording medium, a facsimile (FAX) function that transmits image data to another image processing apparatus connected to a public line or other lines, and a copy function that copies an image formed on a recording medium to another recording medium.

Functions included in the image processing apparatus 10 are not limited to the scanner function, the print function, the FAX function, and the copy function. For example, like a three-dimensional printer, the image processing apparatus 10 may include such a function that forms a three-dimensional object based on data.

The image processing apparatus 10 includes a scanner processor 2, a print processor 4, a FAX processor 6, and a copy processor 8. Further, for example, a document reading unit 12 is disposed in an upper part of the image processing apparatus 10, and an image forming unit 14 is disposed below the document reading unit 12.

The document reading unit 12 includes an optical reader (not illustrated), and a document transport unit 18 located inside a document cover 16. The document transport unit 18 sequentially draws in each sheet of a document 20 placed on a document table 16A provided in the document cover 16, and transports the sheet onto transported-document reading platen glass (not illustrated). Then, an image on the document 20 transported onto the transported-document reading platen glass (not illustrated) is read by the optical reader of the document reading unit 12 as image data. Then, the document transport unit 18 ejects the document 20 from which an image has been read, onto a delivery table 16B provided in the document cover 16.

The image forming unit 14 forms an image based on image data by means of, for example, the electrophotographic system, on a recording medium accommodated in each of paper accommodating units 28 classified according to the type or size of recording medium. The color of an image formed on the recording medium by the image forming unit 14 is not particularly limited. The image may be a color image or a monochrome image.

The scanner processor 2 controls the document reading unit 12 to store, onto a storage medium, the image data of the document 20 that has been read by the document reading unit 12.

The print processor 4 controls the image forming unit 14 to form, on the recording medium, an image based on image data specified by the user.

The FAX processor 6 controls the document reading unit 12 to transmit the image data of the document 20 read by the document reading unit 12, or image data specified by the user, to another specified image processing apparatus having a FAX function that is connected to a public line or other lines. Further, when the FAX processor 6 receives image data from the other image processing apparatus, the FAX processor 6 controls the image forming unit 14 to form an image on the recording medium based on the received image data.

The copy processor 8 controls the image forming unit 14 to form, on the recording medium, an image based on the image data of the document 20 read by the document reading unit 12, or an image based on image data specified by the user.

The image processing apparatus 10 is provided with an operation/display unit 22. The operation/display unit 22 receives a user's operation related to execution of various functions, and displays various information related to each function of the image processing apparatus 10. Specifically, the operation/display unit 22 is provided with devices including a display 24, which has a touch panel superimposed thereon and on which display buttons or other buttons for receiving user operations and various information are displayed, and hardware keys 26 such as a ten-key pad and a Start button.

Further, the operation/display unit 22 includes an external terminal 30. The external terminal 30 serves as an interface to which a portable storage medium is connected to read data stored on the portable storage medium, such as image data, into the image processing apparatus 10, and also serves as an interface with which data residing in the image processing apparatus 10, such as image data read from the document 20 by means of the scanner function, is written to a portable storage medium.

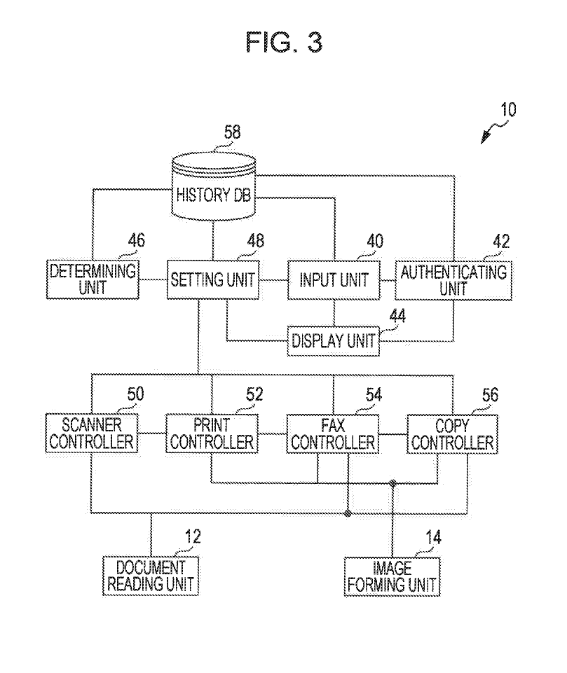

FIG. 3 is a block diagram illustrating an exemplary functional configuration of the image processing apparatus 10. The image processing apparatus 10 includes the document reading unit 12, the image forming unit 14, an input unit 40, an authenticating unit 42, a display unit 44, a determining unit 46, a setting unit 48, a scanner controller 50, a print controller 52, a FAX controller 54, a copy controller 56, and a history database (DB) 58.

The input unit 40 receives, from the user, authentication data and an operation related to execution of a function. The input unit 40 also receives image data from the terminal 3 or a portable storage medium. The input unit 40 records information such as the status of various data received and details on a received operation into the history DB 58, and notifies the setting unit 48 of the recorded information. The input unit 40 further notifies the display unit 44 of details on an operation made by the user.

Examples of an operation related to execution of a function which is received by the input unit 40 include a selecting operation for selecting the function to be executed, an executing operation for instructing that a function be executed, and a setting operation for specifying how a function is to be executed.

An executing operation for instructing that a function be executed refers to the following operation. That is, the user depresses, for example, an execution button displayed on the operation/display unit 22, and executes one of the scanner function, the print function, the FAX function, and the copy function included in the image processing apparatus 10.

A setting operation for specifying how a function is to be executed refers to the following operation. That is, before a user depresses an execution button for the function that the user desires to execute, the user depresses, for example, a button displayed on the display 24 and indicating a setting attribute associated with each setting item used to specify how a function is to be executed. The user thus sets, on the image processing apparatus 10, how the function desired by the user is to be executed.

In the following description, a function that the user is likely to be about to execute will be sometimes referred to as “expected function”.

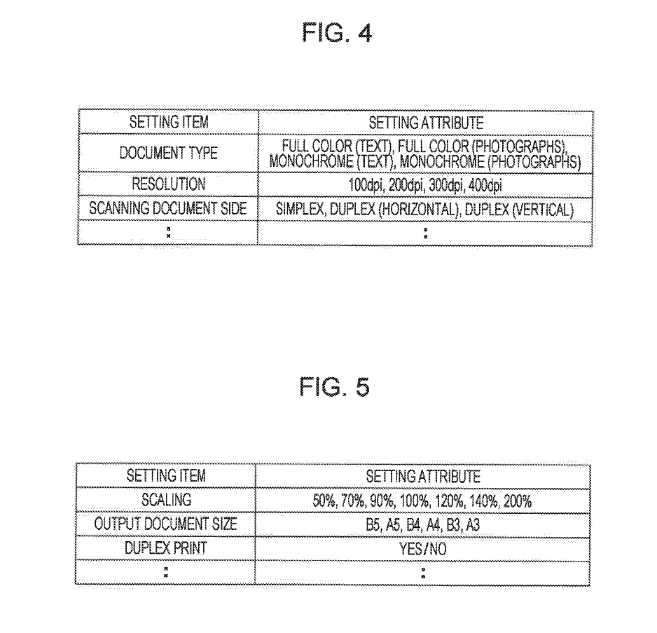

Setting items that specify how a function is to be executed are associated with each function in advance. For example, FIG. 4 illustrates an example of setting items and setting attributes that are associated with the scanner function.

Examples of setting items for the scanner function include “Document Type”, “Resolution”, and “Scanning Document Side”. “Document Type” is a setting item for setting the details of an image drawn on the document 20. “Resolution” is a setting item for setting the precision with which the document 20 is to be read by the document reading unit 12. “Scanning Document Side” is a setting item for setting the side of the document 20 on which an image is drawn.

For example, the type of the document 20 is associated with the following setting attributes: “Full color (text)” containing predominantly text displayed in chromatic colors, “Full color (photographs)” containing predominantly photographs displayed in chromatic colors, “Monochrome (text)” containing predominantly text displayed in achromatic colors, and “Monochrome (photographs)” containing predominantly photographs displayed in achromatic colors. The image processing apparatus 10 controls how the document is to be read by the document reading unit 12, in accordance with a setting attribute specified as the type of the document 20. For example, if the document 20 is predominantly text-based, the image processing apparatus 10 controls how the document is to be read by the document reading unit 12 such that an optical character recognition (OCR) process for recognizing an image of the document 20 as text is activated in accordance with the corresponding color characteristics.

Resolution is associated with, for example, the following setting attributes: 100 dpi, 200 dpi, 300 dpi, and 400 dpi. In this regard, “dpi” is an abbreviation of “dots per inch”, and represents how finely one inch (=approximately 25.4 mm) is divided in reading the document 20. The higher the dpi value, the finer the details of the document 20 read into the image processing apparatus 10 as image data.

Scanning Document Side is associated with, for example, the following setting attributes: “Simplex” indicating that the image to be read is drawn on one side of the document 20, “Duplex (horizontal)” indicating that the image to be read is drawn on both sides of the document 20 with the pages of the document 20 turned horizontally, and “Duplex (vertical)” indicating that the image to be read is drawn on both sides of the document 20 with the pages of the document 20 turned vertically. The image processing apparatus 10 controls, in accordance with a setting attribute specified as Scanning Document Side, features such as the side of the document 20 to be read by the document reading unit 12.

FIG. 5 illustrates an example of setting items and setting attributes that are associated with the print function.

Examples of setting items for the print function include “Scaling”, “Output Document Size”, and “Duplex Print”. “Scaling” is a setting item for setting the size of an image corresponding to image data. “Output Document Size” is a setting item for setting the size of the recording medium on which an image based on image data is to be formed. “Duplex Print” is a setting item for setting on which side of a target recording medium an image based on image data is to be formed. Further, each individual setting item is associated with, for example, setting attributes as illustrated in FIG. 5.

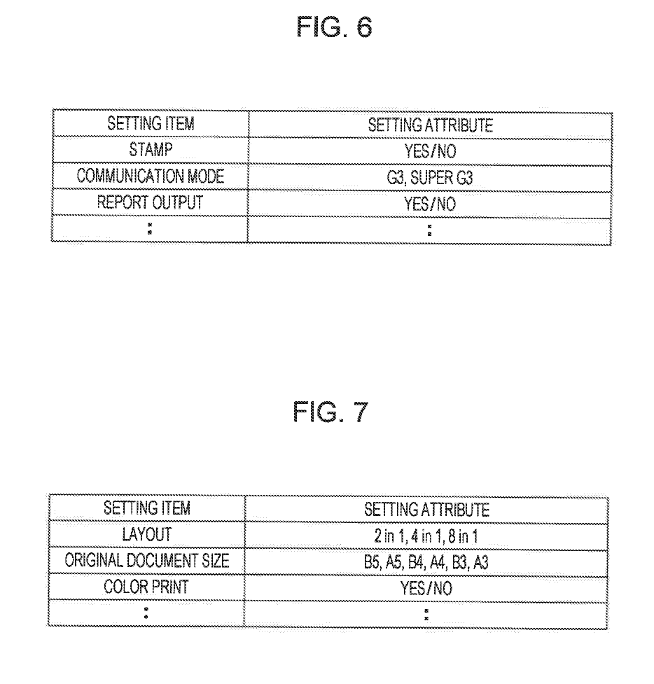

FIG. 6 illustrates an example of setting items and setting attributes that are associated with the FAX function.

Examples of setting items for the FAX function include “Stamp”, “Communication Mode”, and “Report Output”. “Stamp” is a setting item for setting whether to place a stamp on the document 20 read by the document reading unit 12. Communication Mode” is a setting item for setting the protocol for communication with the communicating party. “Report Output” is a setting item for setting whether to output, at the end of communication, a recording medium on which the communication results are recorded. Further, each individual setting item is associated with, for example, setting attributes as illustrated in FIG. 6.

FIG. 7 illustrates an example of setting items and setting attributes that are associated with the copy function.

Examples of setting items for the copy function include “Layout”, “Original Document Size”, and “Color Print”. “Layout” is a setting item for setting the number of pages of the document 20 displayed per page of the recording medium. “Original Document Size” is a setting item for setting the size of the document 20 read by the document reading unit 12. “Color Print” is a setting item for setting whether to form a monochrome image on the recording medium by use of an achromatic pigment or form a color image on the recording medium by use of a chromatic pigment.

It is needless to mention that an example of setting items and setting attributes for the corresponding function depicted in each of FIGS. 4 to 7 is only illustrative, and other setting items and setting attributes may be associated with each corresponding function.

The authenticating unit 42 receives authentication information from the input unit 40, and performs authentication as to whether the received authentication information is the authentication information of the user who is permitted to use the image processing apparatus 10. The authenticating unit 42 records the authentication result into the history DB 58, and notifies the display unit 44 of the recorded authentication result. Then, if the user is not an authenticated user, for example, the authenticating unit 42 instructs the input unit 40 not to accept operations or other inputs made by the non-authenticated user, thus disabling the non-authenticated user from using the image processing apparatus 10.

The display unit 44 displays, on the display 24 of the operation/display unit 22, an execution button for a function and setting buttons for various setting items that specify how the function is to be executed, as well as various information related to operation of the image processing apparatus 10, for example, information such as the result of authentication in the authenticating unit 42 or out-of-paper condition on the paper accommodating unit 28.

When a button displayed on the display 24 of the operation/display unit 22, or the hardware key 26 is depressed by an authenticated user, the display unit 44 receives information related to the button or the hardware key 26 depressed by the authenticated user from the input unit 40, and causes the screen displayed on the display 24 to transition to another screen in accordance with the information indicated by the depressed button or hardware key 26.

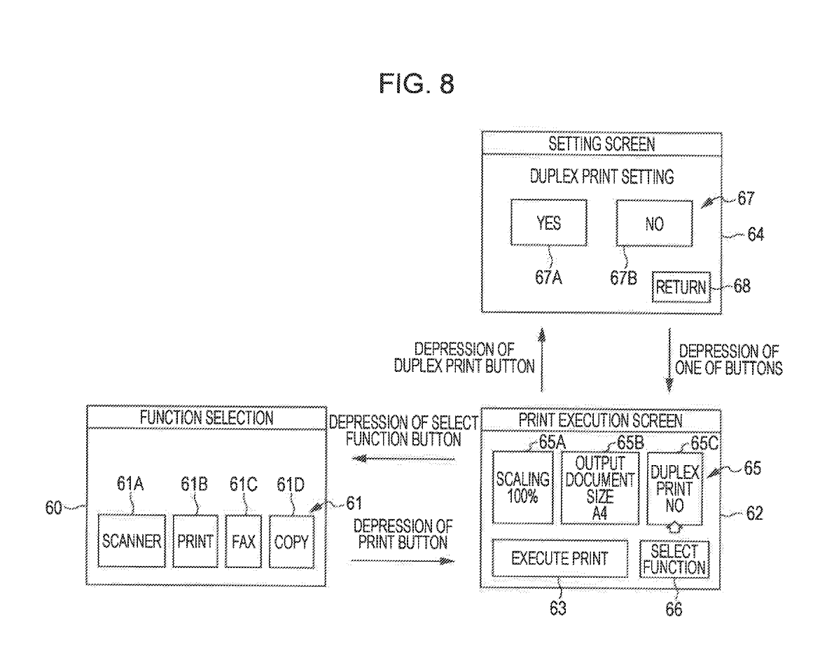

FIG. 8 illustrates an example of how the display unit 44 causes the screen displayed on the display 24 to transition.

For example, a function selection screen 60 shows the following buttons each corresponding to a function included in the image processing apparatus 10: a Scanner button 61A, a Print button 61B, a FAX button 61C, and a Copy button 61D (the buttons 61A to 61D will be generically referred to as “function selecting button 61” hereinafter). When the authenticated user depresses the function selecting button 61 corresponding to a given function, an execution screen 62 corresponding to the depressed function selecting button 61 is displayed. The following description of FIG. 8 assumes that the authenticated user has depressed the Print button 61B.

The execution screen 62 corresponding to the print function shows, for example, an execution button 63 for executing a function selected on the function selection screen 60 (the print function in this case), a function selecting button 66 for transitioning to the function selection screen 60, setting item buttons 65 (a Scaling button 65A, an Output Document Size button 65B, and a Duplex Print button 65C) corresponding to various setting items related to the function selected on the function selection screen 60 (the print function in this case).

Each of the setting item buttons 65 shows, together with the name of the corresponding setting item, a setting attribute set for the setting item. For example, for the Duplex Print button 65C, “Duplex Print” represents the name of the setting item, and “No” represents the setting attribute for the setting item “Duplex Print” set on the image processing apparatus 10.

When one of the setting item buttons 65 is depressed by the authenticated user, the display unit 44 displays a setting screen 64 corresponding to the depressed setting item button 65. For example, if the Duplex Print button 65C is depressed, the display unit 44 displays, on the setting screen 64, attribute setting buttons 67 for setting the setting items corresponding to the setting item Duplex Print illustrated in FIG. 5. In the example illustrated in FIG. 5, setting attributes for the setting item Duplex Print include “Yes” and “No”. Accordingly, the display unit 44 displays a “Yes” button 67A and a “No” button 67B on the setting screen 64 as the attribute setting buttons 67.

When one of the attribute setting buttons 67 or a Return button 68 is depressed by the authenticated user, the display unit 44 displays the execution screen 62. In this case, the display unit 44 displays, in the Duplex Print button 65C on the execution screen 62, a setting attribute that has been set on the setting screen 64. For example, if the “Yes” button 67A is depressed on the setting screen 64, “Duplex Print: Yes” is displayed in the Duplex Print button 65C.

Further, the display unit 44 receives the result of user authentication from the authenticating unit 42. Then, if the user is an authenticated user, for example, the display unit 44 displays the function selection screen 60, the execution screen 62, and the setting screen 64 illustrated in FIG. 8 on the display 24, thus allowing the authenticated user to continue using the image processing apparatus 10.

If the user is not an authenticated user, for example, instead of the function selection screen 60, the execution screen 62, and the setting screen 64 illustrated in FIG. 8, the display unit 44 displays “Please login again” or other messages on the display 24 to prompt the user to perform authentication again. The term “login” used herein refers to a user's operation of entering authentication information to the image processing apparatus 10.

When the display unit 44 displays, in the setting item button 65 on the execution screen 62, the setting attribute set on the image processing apparatus 10, the display unit 44 displays a setting attribute that has already been set by the setting unit 48 described later and is provided as notification to the display unit 44.

The history DB 58 is connected to the input unit 40, the authenticating unit 42, the determining unit 46, and the setting unit 48. The history DB 58 records the following pieces of information in chronological order as history information: the results of authentication performed by the authenticating unit 42, and the setting attribute for each setting item that has been set by the setting unit 48 described later, such as the status of authentication data and image data received by the input unit 40 and information about an operation made by an authenticated user.

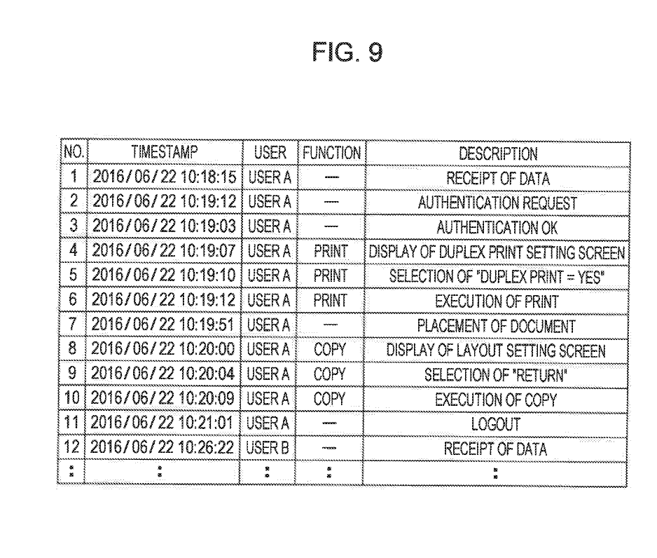

FIG. 9 illustrates an example of the data structure of history information recorded in the history DB 58.

As illustrated in FIG. 9, the history DB 58 records history information in chronological order. The history information includes information related to “No.”, “Timestamp”, “User”, “Function”, and “Description” associated with each other in the row-wise direction.

The “No.” field records a management number for uniquely identifying each data string. For example, at the time when history information is recorded into the history DB 58, an integer that does not overlap with other numbers is given by the history DB 58 as this management number.

The “Timestamp” field records, in year-month-day-hour-minute-second format, for example, the time of occurrence of the event to be recorded. It is needless to mention that the timestamp may include units smaller than milliseconds. Instead of the time of occurrence of the event to be recorded, the time at which the event is recorded into the history DB 58 may be used.

The “User” field records, for example, the user name of a user attempting to execute a function. The user name is acquired from authentication information received by the input unit 40. If image data or other data is received from the terminal 3 before authentication information is entered with the input unit 40, the user name may be identified from, for example, an IP address assigned to the terminal 3. If a portable storage medium is connected before authentication information is entered with the input unit 40, the user name of the owner of the portable storage medium may be identified from, for example, a serial number such as a device ID assigned to the portable storage medium.

The “Function” field records the name of the function that the user is attempting to execute. Specifically, the “Function” field records the name of the function corresponding to the execution button 63 depressed by an authenticated user.

The “Description” field records, for example, the status of various data received by the input unit 40, details on user's operations related to execution of each function, and the result of authentication performed in the authenticating unit 42.

Information recorded in the history DB 58 illustrated in FIG. 9 indicates the following sequence of events. That is, after data is received from the terminal 3 assigned to User A or other devices (No. 1), authentication information is received by the input unit 40 from User A (No. 2), and User A is authenticated to be an authenticated user as a result of authentication in the authenticating unit 42 (No. 3). Further, User A depresses the Duplex Print button 65C on the execution screen 62 to display the setting screen 64 for duplex printing (No. 4), and after selecting the “Yes” button 67A (No. 5), User A depresses the execution button 63 to execute the print function (No. 6).

Subsequently, User A places the document 20 on the document table 16A (No. 7), and depresses, on the execution screen 62 for the copy function, the setting item button 65 corresponding to layout (No. 8), but then User A depresses the Return button 68 on the setting screen 64 related to layout while leaving the current setting attribute unchanged (No. 9), and depresses the execution button 63 for copying to execute the copy function (No. 10).

Thereafter, User A logs out (No. 11), and receives data from the terminal assigned to User B or other devices (No. 12). The numbers in parentheses in the above description represent management numbers for history information.

As described above, the history DB 58 records operations related to execution of each function, history information about input/output of various data to/from the image processing apparatus 10, and actions made by an authenticated user in executing each function, such as placement of the document 20 on the document table 16A or insertion of a portable storage medium into the external terminal 30. Placement of a recording medium on the document table 16A is detected by a sensor, and recorded into the history DB 58.

The determining unit 46 acquires history information recorded in the history DB 58. Then, before the user selects the function to be executed on the operation/display unit 22 after being authenticated as an authenticated user, the determining unit 46 determines, based on the history information, an expected function that the authenticated user is likely to be about to execute. Further, the determining unit 46 determines, based on the history information, a setting attribute for each setting item that specifies how the determined expected function is to be executed.

The method with which the determining unit 46 determines an expected function and a setting attribute for each setting item related to the expected function will be described later.

The determining unit 46 notifies the setting unit 48 of the determined expected function and the determined setting attribute for each setting item related to the expected function.

The setting unit 48 sets each setting item related to the expected function received from the determining unit 46 to the setting attribute received from the determining unit 46. The setting unit 48 then notifies the display unit 44 of the expected function likely to be executed by the authorized user, and the setting attribute for each setting item related to the expected function.

Upon receiving the expected function and the corresponding setting attribute from the determining unit 46, the display unit 44 displays, on the display 24, the execution screen 62 for the expected function determined by the determining unit 46.

At this time, the display unit 44 displays, on the execution screen 62, the setting item buttons 65 showing setting attributes for individual setting items related to the expected function determined by the determining unit 46, together with the execution button 63 for the expected function.

If the function that the authenticated user is about to execute is the function displayed on the execution screen 62, the authenticated user depresses the execution button 63 that is displayed on the execution screen 62 in advance to instruct the image processing apparatus 10 to execute the function. If the function that the authenticated user is about to execute is different from the function displayed on the execution screen 62, the authenticated user depresses the function selecting button 66 to display the function selection screen 60. Then, the authenticated user depresses the function selecting button 61 corresponding to the function currently being desired to be executed, and depresses, on the execution screen 62, the execution button 63 corresponding to the selected function to execute the desired function.

If the function that the authenticated user instructs to be executed by depressing the execution button 63 is the scanner function, the scanner controller 50 controls the document reading unit 12 so as to read the document 20 in accordance with each setting attribute set by the setting unit 48.

If the function that the authenticated user instructs to be executed by depressing the execution button 63 is the print function, the print controller 52 controls the image forming unit 14 so as to form an image on the recording medium in accordance with each setting attribute set by the setting unit 48.

If the function that the authenticated user instructs to be executed by depressing the execution button 63 is the FAX function, the FAX controller 54 controls the document reading unit 12 so as to read the document 20 placed on the document table 16A in accordance with each setting attribute set by the setting unit 48. Then, the FAX controller 54 transmits the image data of the document 20 read by the document reading unit 12 to a specified image processing apparatus having the FAX function. Further, when FAX image data is received from another image processing apparatus, the FAX controller 54 controls the image forming unit 14 so as to form an image on the recording medium in accordance with each setting attribute set by the setting unit 48.

If the function that the authenticated user instructs to be executed by depressing the execution button 63 is the copy function, the copy controller 56 controls the document reading unit 12 so as to read the document 20 placed on the document table 16A in accordance with each setting attribute set by the setting unit 48. Then, the copy controller 56 controls the image forming unit 14 so as to form, on the recording medium, an image corresponding to the document 20 that has been read in accordance with each setting attribute set by the setting unit 48.

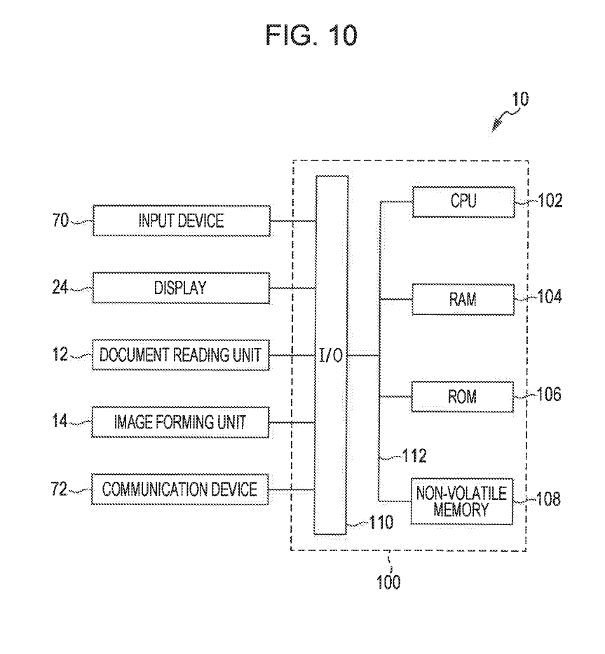

Next, the configuration of the major portion of the electrical system of the image processing apparatus 10 according to the first exemplary embodiment will be described with reference to FIG. 10.

The input unit 40, the authenticating unit 42, the display unit 44, the determining unit 46, and the setting unit 48 of the image processing apparatus 10 are implemented by using, for example, a computer 100.

The computer 100 includes a central processing unit (CPU) 102, a random access memory (RAM) 104, a read only memory (ROM) 106, a non-volatile memory 108, and an input/output interface (IO) 110 that are connected via a bus 112. The I/O 110 is connected with the document reading unit 12, the image forming unit 14, the display 24, an input device 70, and a communication device 72.

The CPU 102 has, for example, a built-in calendar function. The CPU 102 uses the calendar function to acquire date and time information such as the current year/month/day, time, and day of week.

The input device 70 includes the touch panel and the hardware keys 26 placed in the operation/display unit 22, and the external terminal 30 to which a portable storage medium is connected.

The communication device 72 connects the image processing apparatus 10 to the communication line 5 to which the terminal 3 is connected, thus transmitting and receiving data to and from the terminal 3. The communication device 72 also connects the image processing apparatus 10 to a public line, thus transmitting and receiving image data to and from another image processing apparatus having the FAX function by means of the FAX function.

It is needless to mention that the devices connected to the I/O 110 illustrated in FIG. 10 are only illustrative, and not limited to those illustrated in FIG. 10.

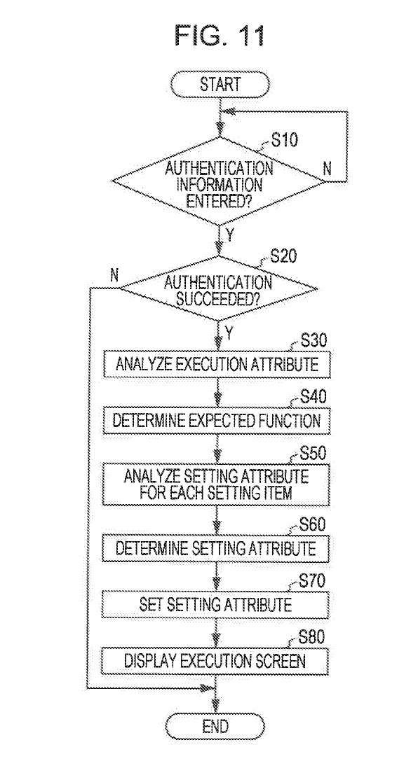

Next, operation of the image processing apparatus 10 will be described. FIG. 11 is a flowchart of an example of an operation support process that is executed by the CPU 102 at power-on of the image processing apparatus 10.

A program for executing the operation support process, which is an example of an image processing program for the image processing apparatus 10, is pre-installed into the ROM 106, for example. It is assumed that history information on the authenticated user's past usage of the image processing apparatus 10 is recorded in the history DB 58 in advance.

First, at step S10, the CPU 102 determines whether authentication information has been entered by the user by, for example, operating the touch panel or the hardware key 26, which is an example of the input device 70. If no authentication information has been entered, step S10 is repeated until the user enters authentication information. If authentication information has been entered, the processing transfers to step S20.

The user may not necessarily enter authentication information by operating the touch panel or hardware key 26. For example, the user may enter authentication information by causing a reading device to read the contents of an integrated circuit (IC) card on which authentication information is recorded in advance.

At step S20, the CPU 102 determines whether the authentication information entered at step S10 is the authentication information of the user who is permitted to use the image processing apparatus 10.

If the authentication information entered at step S10 is not the authentication information of the user who is permitted to use the image processing apparatus 10, that is, if authentication fails, the operation support process illustrated in FIG. 11 is ended without executing steps S30 to S80 described later.

If the authentication information entered at step S10 is the authentication information of the user who is permitted to use the image processing apparatus 10, that is, if authentication succeeds, the processing transfers to step S30.

Whether the authentication succeeds is determined by, for example, referencing an authenticated-user table stored in advance in a predetermined area of the non-volatile memory 108, and determining whether the authenticated-user table contains the authentication information entered at step S10. The authenticated-user table contains authentication information of each user who is permitted to use the image processing apparatus 10.

At step S30, the CPU 102 acquires, from the history DB 58, history information of the authenticated user who has been successfully authenticated at step S20.

The CPU 102 uses the acquired history information to analyze an execution attribute for each function that has been executed by the authenticated user so far. An execution attribute is an attribute representing the condition under which a function is executed.

Specifically, the cumulative number of executions of each individual function is aggregated for, for example, each day of week, each time of day, or each combination of day of week and time of day. If the cumulative number of executions of each individual function is to be aggregated for each combination of day of week and time of day, the cumulative number of executions of each individual function is aggregated such that, for example, for the time segment between 10 a.m. or later and before 11 a.m. on Monday, the cumulative number of executions of the scanner function by the authenticated user is N₁, the cumulative number of executions of the print function by the authenticated user is N₂, the cumulative number of executions of the FAX function by the authenticated user is N₃, and the cumulative number of executions of the copy function by the authenticated user is N₄.

The period for aggregating the cumulative number of executions of each function may be set in any units. Although the aggregation period is in units of one hour in the above-mentioned example, the aggregation period may be set in units either longer or shorter than one hour such that, for example, the aggregation period is set in units such as morning and afternoon. The shorter the units of period for aggregating the cumulative number of executions of each function, the more detailed the data obtained on the tendency of execution of each function by the authenticated user.

The execution attribute for each function that has been executed by the authenticated user so far is not limited to that mentioned above. For example, the CPU 102 may analyze the tendency regarding the order in which individual functions have been executed by the authenticated user. Specifically, the CPU 102 aggregates the cumulative number of executions of the next function executed following execution of a specific function. This is because, in some cases, peculiar characteristics are observed for individual authenticated users as to the order in which these users execute individual functions, such that some authenticated users tend to execute the print function and then copy the document 20 output by means of the print function or that some authenticated users tend to copy the document 20 and then transmit the obtained copy to another department by means of the FAX function.

As described above, the CPU 102 analyzes the execution attribute for at least one function that has been executed by the authenticated user so far, and stores the analysis results into, for example, a predetermined area of the RAM 104.

At step S40, the CPU 102 determines, based on the execution attribute for each function analyzed at step S30, an expected function that is likely to be executed by the authenticated user.

For example, if the cumulative numbers of executions of individual functions have been aggregated for each combination of day of week and time of day at step S30, the CPU 102 acquires date and time information by means of the calendar function. Then, the CPU 102 references the cumulative numbers of executions of individual functions aggregated at step S30 that correspond to the current day of week and the current time of day. The CPU 102 then determines, as the expected function, the function that has been executed the greatest cumulative number of times among the individual functions.

The method of determining the expected function at step S40 is not limited to this. For example, suppose that for each individual function, the cumulative number of executions of the function following the last executed function has been aggregated at step S30. In this case, the CPU 102 may reference the cumulative numbers of executions of individual functions, and determine, as the expected function, the function that has been executed the greatest number of times among the individual functions.

That is, the CPU 102 determines, as the expected function, the function that is most likely to be executed in accordance with, among the execution attributes analyzed at step S30, the same execution attribute as the execution attribute associated with the authenticated user at the time when the user is authenticated at step S20.

If the cumulative numbers of executions of individual functions for a specific execution attribute are the same, a function that is associated with the specific execution attribute in advance may be determined as the expected function. For example, the scanner function is associated with the execution attribute “Tuesday” in advance. In this case, suppose that the cumulative number of executions of each of the scanner function and the print function by the authenticated user is N₁, the cumulative number of executions of the FAX function is N₃, and the cumulative number of executions of the copy function is N₄, and these cumulative numbers of executions have the following relationship: N₁>N₃>N₄. In this case, of the scanner function and the print function that have been both executed the cumulative number of times N₁, the scanner function that is associated with this execution attribute in advance may be determined as the expected function.

If multiple execution attributes have been analyzed at step S30, for example, for each of the multiple execution attributes analyzed, the function that is most likely to be executed by the authenticated user is determined as a provisional expected function. Then, the function that has been determined as a provisional expected function the greatest number of times may be determined as the final expected function.

For example, a case is considered in which the following cumulative numbers of executions have been aggregated at step S30 as the first, second, and third execution attributes, respectively: the cumulative number of executions of each function for each month, the cumulative number of executions of each function for each combination of day of week and time of day, and the cumulative number of executions of each function following execution of a specific function.

In this case, if the copy function has been selected as a provisional expected function from the first and second execution attributes, and the FAX function has been selected as a provisional expected function from the third execution attribute, the copy function that has been selected as a provisional expected function the greatest number of times is determined as the final expected function.

At step S50, the CPU 102 acquires, from the history information of the authenticated user acquired at step S30, a piece of history information that records a setting operation made for each of setting items that specify how the expected function determined at step S40 is to be executed.

Then, the CPU 102 uses the acquired history information to analyze, for each setting item, the setting attribute that has been set by the authenticated user for the determined expected function.

Specifically, if the expected function determined at step S40 is the scanner function, the CPU 102 aggregates, for each of the setting items corresponding to the scanner function illustrated in FIG. 4, the cumulative number of times each setting attribute associated with the setting item has been set. For example, the history information of the authenticated user is referenced, and the cumulative number of times each setting attribute has been set is aggregated for each setting item, such that for the setting item “Document Type” related to the scanner function, the cumulative number of times the setting attribute “Full color (text)” has been set is obtained as M₁, the cumulative number of times the setting attribute “Full color (photographs)” has been set is obtained as M₂, the cumulative number of times the setting attribute “Monochrome (text)” has been set is obtained as M₃, and the cumulative number of times the setting attribute “Monochrome (photographs)” has been set is obtained as M₄.

At step S60, the CPU 102 determines, for each setting item, the setting attribute that the authenticated user is likely to set in executing the expected function, based on the cumulative number of times each setting attribute has been set for each setting item analyzed at step S50. Specifically, for each setting item, the setting attribute that has been set the greatest number of times is determined to be the setting attribute that the authenticated user is likely to set in executing the expected function.

At step S70, the CPU 102 sets each setting item for the expected function determined at step S40 to the setting attribute determined for each setting item at step S60.

At step S80, the CPU 102 displays the execution screen 62 for the expected function determined at step S40. At this time, as illustrated in FIG. 8, the CPU 102 displays, on the execution screen 62, the setting item button 65 for each setting item that shows the setting attribute set at step S70, together with the execution button 63 for the expected function determined at step S40.

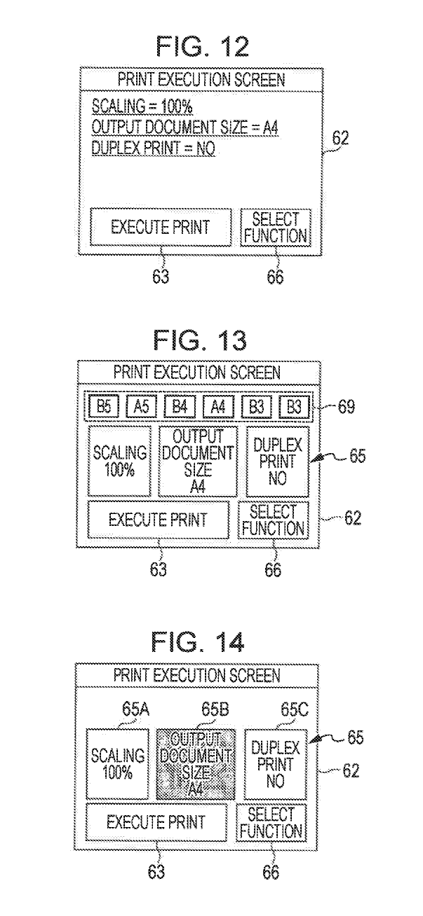

The execution screen 62 may not necessarily be displayed in the manner as illustrated in FIG. 8. For example, the setting attribute for each setting item may be displayed in the form of a character string as illustrated in FIG. 12. Such a character string including a setting attribute is linked to the setting screen 64 for the corresponding setting item. When the authenticated user depresses the character string, the execution screen 62 transitions to the setting screen 64 for the setting item corresponding to the character string being depressed.

As described above, the image processing apparatus 10 according to the first exemplary embodiment uses the history information of the authenticated user recorded in the history DB 58 to determine the expected function from the execution attribute associated with the user at the time when the user is authenticated. Further, the image processing apparatus 10 uses the history information of the authenticated user recorded in the history DB 58 to determine, for each setting item, the setting attribute that the authenticated user is likely to set for the determined expected function, and sets each setting item to the setting attribute thus determined. Then, the image processing apparatus 10 displays, on the display 24 of the operation/display unit 22, for example, the execution button 63 for the determined expected function, and the execution screen 62 showing the setting attribute that has been set for each setting item.

That is, the authenticated user does not need to set each setting item by himself or herself prior to executing the expected function. This reduces the frequency with which a wrong setting attribute is set as a result of, for example, the authenticated user depressing a wrong attribute setting button 67, in comparison to when the authenticated user sets each setting item whenever the authenticated user executes the determined expected function.

If the expected function determined by the image processing apparatus 10, and the function that is about to be executed by the authenticated user are the same, the user only needs to depress the execution button 63 on the displayed execution screen 62 to cause a desired function to be executed in accordance with preset setting attributes.

The processing performed by the image processing apparatus 10 is capable of various modifications. For example, referring to the pieces of history information indicated as Nos. 8 and 9 in FIG. 9, these pieces of history information indicate that the authenticated user has displayed the setting screen 64 related to layout but then depressed the Return button 68 without changing the associated setting attribute.

A setting item for which the authenticated user has displayed the setting screen 64 but has not changed the associated setting attribute as described above is considered to be a setting item of greater importance for the authenticated user than other setting items.

Accordingly, at step S50 of the operation support process illustrated in FIG. 11, the CPU 102 further aggregates the number of times that the authenticated user has displayed the setting screen 64 for a setting item but has not changed the setting attribute associated with the setting item. Then, if the aggregated number of times such display of the setting screen 64 has taken place is equal to or greater than a predetermined value at or above which it is assumed that the authenticated user regards the corresponding setting item as being of greater importance than other setting items, the attribute setting button 67 for setting the setting attribute corresponding to the unchanged setting item is displayed on the execution screen 62.

FIG. 13 illustrates an example of the execution screen 62 in this case. The execution screen 62 illustrated in FIG. 13 includes a display area 69 added to the execution screen 62 illustrated in FIG. 8. The display area 69 displays the attribute setting buttons 67 each used to set a setting attribute for each of setting items for which the authenticated user has displayed the setting screen 64 a predetermined number of times or more without changing the setting item.

Thus, for the setting item that the authenticated user regards as being of greater importance than other setting items, the authenticated user is able to change a setting attribute for the setting item from the execution screen 62 without having to display the setting screen 64 for the setting attribute associated with the setting item.

A setting item that the authenticated user regards as being of greater importance than other setting items may not necessarily be displayed on the execution screen 62 in the manner as illustrated in FIG. 13. For example, the setting item button 65 for a setting item that is regarded by the authenticated user as being of greater importance than other setting items may be displayed differently from other setting item buttons 65.

In the example illustrated in FIG. 14, the text and background color for the setting item button 65B used to set output document size are changed from those of the other setting item buttons 65A and 65C. This enables easy recognition of the setting attribute related to output document size, which is a setting item regarded by the authenticated user as being of greater importance than other setting items. In this case, examples of methods other than changing the text and background color for the setting item button 65 include changing the size or thickness of the text, changing the display of the setting item button 65, and changing the shape of the setting item button 65.

### Second Exemplary Embodiment

In the first exemplary embodiment, information about executing operations and setting operations recorded into the history DB 58 after user authentication is used to set, for each setting item, the setting attribute that has been set by the authenticated user most frequently, and then the execution screen 62 for the expected function is displayed on the display 24 of the operation/display unit 22.

A second exemplary embodiment is directed to the following configuration. That is, the expected function is determined from a record of an operation made by the user before user authentication, and the tendency regarding an operation made by the authenticated user after authentication. Then, after setting, for each setting item, the setting attribute that has been set by the authenticated user most frequently, the execution screen 62 for the expected function is displayed on the display 24.

The exemplary configuration of the image processing apparatus 10 according to the second exemplary embodiment, and the exemplary configuration of the major portion of its electrical system are respectively the same as the exemplary configuration of the image processing apparatus 10 according to the first exemplary embodiment illustrated in FIG. 3, and the exemplary configuration of the major portion of its electrical system illustrated in FIG. 10.

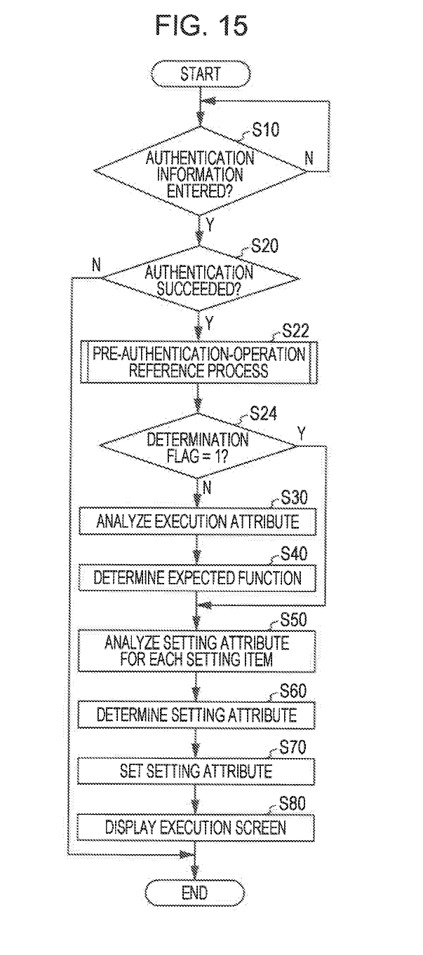

FIG. 15 is a flowchart of an example of an operation support process that is executed by the CPU 102 at power-on of the image processing apparatus 10.

The flowchart of the operation support process illustrated in FIG. 15 differs from the flowchart of the operation support process according to the first exemplary embodiment illustrated in FIG. 11 in that step S22 and step S24 are added. Otherwise, the operation support process is the same as that illustrated in FIG. 11.

At step S22, the CPU 102 references the history DB 58 to perform a pre-authentication-operation reference process. In the pre-authentication-operation reference process, the expected function is determined from a record of an operation made by the authenticated user before being authenticated at step S20, and the tendency regarding an operation made by the authenticated user after authentication. If the expected function is determined through the pre-authentication-operation reference process, a determination flag is set to “1”, and if the expected function is not determined, the determination flag is set to “0”.

Accordingly, the CPU 102 determines at step S24 whether the value of the determination flag is “1”. If the determination is negative, this means that the expected function has not been determined yet. Thus, the CPU 102 executes steps S30 and S40 described above with reference to the first exemplary embodiment to determine the expected function. If the determination is affirmative, this means that the expected function has been already determined at step S22. Thus, the CPU 102 proceeds to step S50 without executing steps S30 and S40, and determines and sets a setting attribute for each setting item related to the determined expected function.

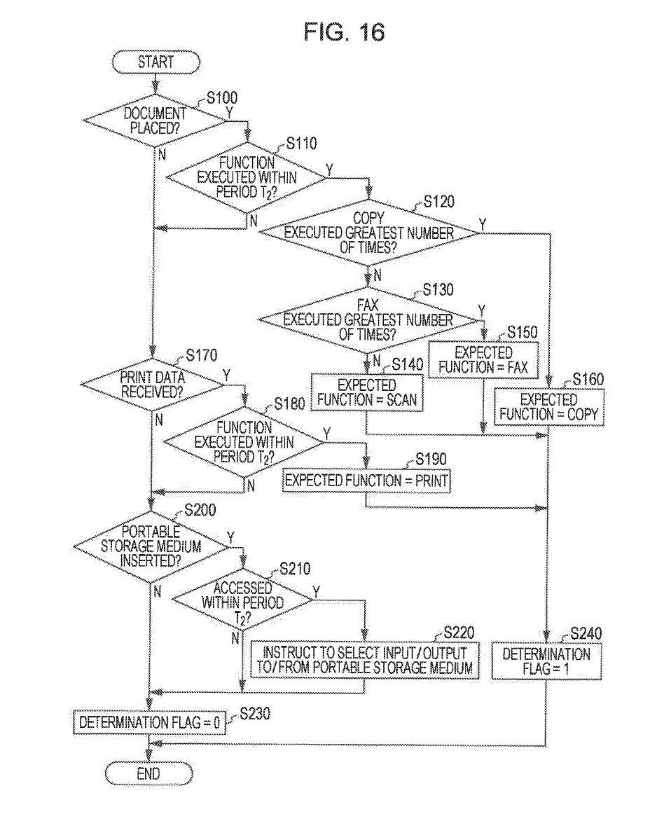

Next, the pre-authentication-operation reference process at step S22 in FIG. 15 will be described with reference to FIG. 16.

Before executing a function of the image processing apparatus 10, the user makes preparations for executing the function. For example, when executing one of the copy function, the FAX function, and the scanner function, the user sometimes places the document 20 on the document table 16A. When executing the print function, the user sometimes transmits the print data being desired to be printed to the image processing apparatus 10 from the terminal 3.

In the pre-authentication-operation reference process, an operation made by the user before authentication, and information about an operation that has been made by the user after authentication are acquired from history information recorded in the history DB 58 to determine the expected function that the user is expecting to execute.

First, at step S100, the CPU 102 acquires the history information of the authenticated user who has been successfully authenticated at step S20 from the history DB 58. Then, the CPU 102 determines whether the acquired history information contains a piece of history information indicating that the authenticated user has placed the document 20 on the document table 16A within a predetermined period T₁ that precedes the date and time represented by the timestamp of the piece of history information indicating the receipt of authentication information from the authenticated user at step S10. At this time, the period T₁ is set to the maximum period of time considered to be necessary for the authenticated user to enter authentication information into the image processing apparatus 10 after starting preparations for executing a function. That is, if there is no history information indicating that the authenticated user has placed the document 20 on the document table 16A within the period T₁, the absence of such history information can be regarded as indicating that there is no correlation between the preparatory operation (the placement of the document 20 on the document table 16A in this case) made by the authenticated user before authentication, and the function that is about to be executed by the authenticated user.

Then, if the determination at step S100 is affirmative, the processing transfers to step S110, and if the determination is negative, the processing transfers to step S170.

At step S110, the CPU 102 determines whether the history information of the authenticated user acquired at step S100 contains a piece of history information indicating that the authenticated user has executed one of the copy function, the FAX function, and the scanner function within a period T₂ after placing the document 20 on the document table 16A.

If the determination at step S110 is affirmative, the processing transfers to step S120, and if the determination is negative, the processing transfers to step S170.

At step S120, the CPU 102 determines whether the copy function has been executed the greatest number of times, among individual functions executed by the authenticated user within the period T₂ after placing the document 20 on the document table 16A.

If the determination at step S120 is affirmative, the processing transfers to step S160, and if the determination is negative, the processing transfers to step S130. The criterion for the determination at step S120 is not limited to the criterion mentioned above. For example, an affirmative determination may be made if the copy function has been executed the greatest number of times, and if the number of executions is equal to or greater than a predetermined number of executions (reference execution count).

A comparison against a reference execution count allows for accurate determination of whether the authenticated user tends to execute the copy function within the period T₂ after placing the document 20 on the document table 16A, in comparison to when the respective numbers of executions of the copy function, the FAX function, and the scanner function are compared with each other to determine the expected function.

At step S160, since the copy function has been executed the greatest number of times by the authenticated user after placement of the document 20 on the document table 16A, the CPU 102 determines the copy function to be the expected function. Then, at step S240, the CPU 102 sets the determination flag to “1”.

At step S130 to which the processing transfers if the determination at step S120 is negative, the CPU 102 determines whether the FAX function has been executed the greatest number of times, among individual functions that the authenticated user has executed within the period T₂ after performing a preparatory operation. In this case, the CPU 102 may further compare the number of executions against a reference execution count as described above.

If the determination at step S130 is affirmative, the processing transfers to step S150, and if the determination is negative, the processing transfers to step S140.

At step S140, since the scanner function has been executed the greatest number of times by the authenticated user after placement of the document 20 on the document table 16A, the CPU 102 determines the scanner function to be the expected function. Then, at step S240, the CPU 102 sets the determination flag to “1”.

At step S150, since the FAX function has been executed the greatest number of times by the authenticated user after placement of the document 20 on the document table 16A, the CPU 102 determines the FAX function to be the expected function. Then, at step S240, the CPU 102 sets the determination flag to “1”.

At step S170 to which the processing transfers if the determinations at steps S100 and S110 are negative, the CPU 102 references the history information acquired at step S100. Then, the CPU 102 determines whether the acquired history information contains a piece of history information indicating that print data has been received from the terminal 3 assigned to the authenticated user within the predetermined period T₁ that precedes the date and time represented by the timestamp of the piece of history information indicating the receipt of authentication information from the authenticated user at step S10.

If the determination at step S170 is affirmative, the processing transfers to step S180, and if the determination is negative, the processing transfers to step S200.

At step S180, the CPU 102 references the history information acquired at step S100. Then, the CPU 102 determines whether the acquired history information contains a piece of history information indicating that the authenticated user has executed the print function within the period T₂ after receipt of the print data from the terminal 3 assigned to the authenticated user.

If the determination at step S180 is affirmative, the processing transfers to step S190, and if the determination is negative, the processing transfers to step S200.

At step S190, since it can be regarded that when print data is received from the authenticated user, the authenticated user tends to execute the print function within the period T₂ after the receipt of print data, the CPU 102 determines the print function to be the expected function. Then, at step S240, the CPU 102 sets the determination flag to “1”.

At step S200 to which the processing transfers if the determinations at steps S170 and S180 are negative, the CPU 102 references the history information acquired at step S100. Then, the CPU 102 determines whether the acquired history information contains a piece of history information indicating that the authenticated user has inserted a portable storage medium into the external terminal 30 within the predetermined period T₁ that precedes the date and time represented by the timestamp of the piece of history information indicating the receipt of authentication information from the authenticated user at step S10.

If the determination at step S200 is affirmative, the processing transfers to step S210, and if the determination is negative, the processing transfers to step S230.

At step S210, the CPU 102 references the history information of the authenticated user acquired at step S100, and determines whether the acquired history information contains a piece of history information indicating that the authenticated user has accessed the portable storage medium within the period T₂ after inserting the portable storage medium into the external terminal 30, that is, whether the authenticated user has executed reading of data from the portable storage medium or writing of data to the portable storage medium within the period T₂.

If the determination at step S210 is affirmative, the processing transfers to step S220, and if the determination is negative, the processing transfers to step S230.

At step S220, since it can be regarded that the authenticated user tends to access the portable storage medium within the period T₂ after inserting the portable storage medium into the external terminal 30, an instruction (access-mode setting instruction) instructing that the attribute setting button 67 for setting the mode of access to the portable storage medium be displayed on the execution screen 62 is stored into a predetermined area of the RAM 104, for example.

The access-mode setting instruction stored into the RAM 104 at step S220 is read at step S80 illustrated in FIG. 15, for example. When an access-mode setting instruction is being issued, the setting item button 65 for setting the mode of data access is displayed on the execution screen 62. Modes of data access with respect to a portable storage medium include reading of data from the portable storage medium, and writing of data to the portable storage medium.

At step S230, the CPU 102 sets the determination flag to “0”, thus providing notification that the expected function has not been successfully determined by the pre-authentication-operation reference process.

The above completes the pre-authentication-operation reference process indicated at step S22 in FIG. 15.

The above description is directed to a case in which, at each of steps S110, S180, and S210, the CPU 102 determines whether the history DB 58 contains a specific piece of history information indicating that the authenticated user has executed, within the period T₂ after performing a preparatory operation, a specific operation that is subject to determination in the corresponding process. Further, the following condition may be added to the above condition: an affirmative determination is made if there are a predetermined number or more pieces of history information.

Although the numbers of executions of multiple functions are compared with each other at steps S120 and S130, the ratios of execution of these functions may be used instead of the numbers of executions.

As described above, the image processing apparatus 10 according to the second exemplary embodiment determines the expected function from a record of an operation made by the authenticated user before authentication, and the tendency regarding an operation made by the authenticated user after authentication. Information about an operation made by the authenticated user before authentication is indicative of a function that the authenticated user desires to execute. Thus, an improvement in the accuracy of determination of the expected function is expected in comparison to when the expected function is determined from the tendency regarding an operation made by the authenticated user after authentication.

Various modifications are applicable to the image processing apparatus 10 according to the second exemplary embodiment.

As described above, information about an operation made by the authenticated user before authentication is indicative of a function that the authenticated user desires to execute. Therefore, if the authenticated user has performed, prior to authentication, an operation that is performed with a relatively low frequency, even though the operation is one that is performed rather infrequently, the authenticated user is likely to execute a function associated with the operation.

Accordingly, if an operation count indicating the number of times an operation has been performed by the authenticated user before authentication is less than a predetermined operation count, the image processing apparatus 10 determines, as the expected function, a function that is associated in advance with the operation that has been performed a number of times less than the predetermined operation count. The predetermined operation count in this case is a reference value used in determining the frequency with which an operation has been performed. If the number of times an operation has been performed is less than this predetermined operation count, the operation is determined to be an operation performed with low frequency. The value set as the predetermined operation count is not particularly limited. This value may be determined by, for example, an experiment.

Specifically, for example, the CPU 102 associates the print function with receipt of print data in advance. Then, the CPU 102 acquires, from the history DB 58, the history information of the authenticated user who has been successfully authenticated at step S20 illustrated in FIG. 15. The CPU 102 then determines whether the history information contains a piece of history information indicating that print data has been received from the terminal 3 assigned to the authenticated user within the predetermined period T₁ that precedes the date and time represented by the timestamp of the piece of history information indicating receipt of authentication information from the authenticated user. If the determination is affirmative, the CPU 102 counts, for each function, the total number of pieces of history information indicating that print data has been received from the terminal 3 assigned to the authenticated user within the period of time from when the authenticated user finishes execution of a given function to when the authenticated user performs authentication again to execute the next function. Then, if the number of times the authenticated user has performed the operation of transmitting print data to the image processing apparatus 10 is less than a predetermined operation count, the CPU 102 determines the print data as the executed function in precedence to step S100 illustrated in FIG. 16.

### Third Exemplary Embodiment

A third exemplary embodiment is directed to the image processing apparatus 10 that uses the percentage of correct predictions of the expected function determined by the image processing apparatus 10, for when the image processing apparatus 10 performs the subsequent determinations of an expected function.

The exemplary configuration of the image processing apparatus 10 according to the third exemplary embodiment, and the exemplary configuration of the major portion of its electrical system are respectively the same as the exemplary configuration of the image processing apparatus 10 according to the first exemplary embodiment illustrated in FIG. 3, and the exemplary configuration of the major portion of its electrical system illustrated in FIG. 10.

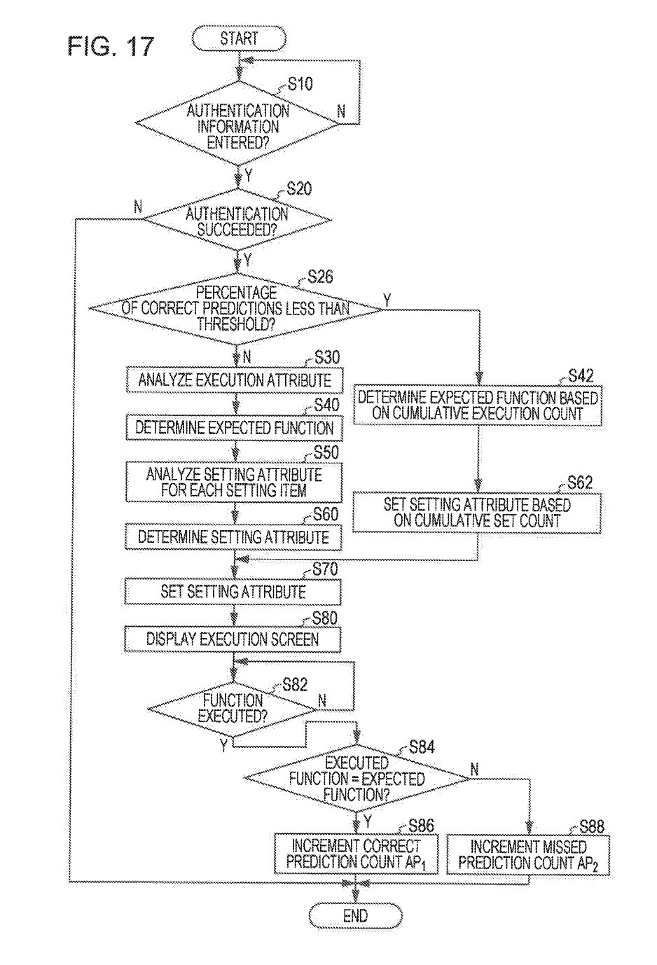

FIG. 17 is a flowchart of an example of an operation support process that is executed by the CPU 102 at power-on of the image processing apparatus 10.

The flowchart of the operation support process illustrated in FIG. 17 differs from the flowchart of the operation support process according to the first exemplary embodiment illustrated in FIG. 11 in that steps S26, S42, S62, and S82 to S88 are added. Otherwise, the operation support process is the same as that illustrated in FIG. 11.

After the CPU 102 displays, at step S80, the execution screen 62 for the expected function that has been determined, the CPU 102 detects, at step S82, whether the execution button 63 has been depressed on the execution screen 62 to thereby determine whether some function has been executed. If no function has been executed, step S82 is repeated until the authenticated user executes some function. If some function has been executed, the processing transfers to step S84.

At step S84, the CPU 102 determines whether the actually executed function is the expected function determined at step S40. If the determination is affirmative, the processing transfers to step S86, and if the determination is negative, the processing transfers to step S88.

At step S86, the CPU 102 increments a “correct prediction count AP₁” by one. The correct prediction count AP₁ represents the number of times a determined expected function has proven to be the actually executed function. Then, the CPU 102 stores the correct prediction count AP₁ into, for example, a predetermined area of the RAM 104.

At step S88, the CPU 102 increments a “missed prediction count AP₂” by one. The missed prediction count AP₂ represents the number of times a determined expected function has proven not to be the actually executed function. Then, the CPU 102 stores the missed prediction count AP₂ into, for example, a predetermined area of the RAM 104.

Then, in the subsequent executions of the operation support processes illustrated in FIG. 17, after user authentication is performed at step S20, the CPU 102 calculates the percentage of correct predictions, P, of the expected function at step S26. Specifically, the CPU 102 uses the correct prediction count AP₁ aggregated at step S86, and the missed prediction count AP₂ aggregated at step S88 to calculate the percentage of correct predictions P as follows: P=AP₁/(AP₁+AP₂).

Then, the CPU 102 determines whether the calculated percentage of correct predictions P is less than a threshold. This threshold is set to a value corresponding to the percentage of correct predictions P below which the authenticated user begins to feel annoyed by the hassle of having to switch to the execution screen 62 for a function different from the expected function. This value is determined by, for example, an experiment performed by actually using the image processing apparatus 10, or computer simulation based on the design specifications of the image processing apparatus 10.

If the percentage of correct predictions P is equal to or higher than the threshold, the processing transfers to step S30 to perform the operation support process described above. If the percentage of correct predictions P is less than the threshold, the processing transfers to step S42.

At step S42, the CPU 102 references the history DB 58, and determines, as the expected function, the function that has been executed the greatest cumulative number of times by all users including the authenticated user and the other users.

The method of determining the expected function at step S42 is not limited to this. For example, a predetermined function may be determined as the expected function.

Then, at step S62, for each setting item related to the expected function determined at step S42, the CPU 102 determines the setting attribute that has been set the greatest cumulative number of times by all users including the authenticated user and the other users. The determined setting attribute for each setting item is set at step S70.

The method of determining a setting attribute for each setting item at step S62 is not limited to this. For example, a predetermined setting attribute may be associated with each setting item.

As described above, the image processing apparatus 10 according to the third exemplary embodiment uses the percentage of correct predictions P of the expected function determined by the image processing apparatus 10, for when the image processing apparatus 10 performs the subsequent determinations of an expected function. If the percentage of correct predictions P is less than a threshold, the function that has been executed the greatest number of times by all users including the authenticated user and the other users, and the setting attribute for each setting item that has been set the greatest number of times by all the users mentioned above, are respectively determined as the expected function for the authenticated user, and the setting attribute set by the authenticated user for each setting item.

In the foregoing description, the percentage of correct predictions P and a threshold are compared at step S26 illustrated in FIG. 17. Alternatively, in some exemplary embodiments, the correct prediction count AP₁ is compared with another threshold, and the processing transfers to step S42 if the correct prediction count AP₁ is below the threshold.

Although the exemplary embodiments of the present invention have been described above, the scope of the present invention is not limited to the exemplary embodiments. Various changes or improvements may be made to the exemplary embodiments without departing from the scope of the present invention, and such changes or improvements also fall within the technical scope of the present invention. For example, the order of various processes may be changed without departing from the scope of the present invention.

The authentication and various operations performed with the image processing apparatus 10 may be performed from the terminal 3 by using application software that is provided in advance for the image processing apparatus 10. Further, a server may be connected to the communication line 5, and the history DB 58 may be placed on the server.

Although the foregoing description of the exemplary embodiments is directed to an example in which the operation support process in the image processing apparatus 10 is implemented by software, processes equivalent to those of the flowchart illustrated in FIGS. 11, 15, and 17 may be implemented by hardware. This allows for faster processing than when the operation support process is executed by software.

A case is also conceivable where the image processing apparatus 10 receives print data from, other than the terminal 3 and a portable storage medium, a device constituting a cloud service connected to the communication line 5. The above-mentioned operation support process is also applicable to such a case.

Although the foregoing description of the exemplary embodiments is directed to a case in which the image processing program is installed in the ROM 106, this is not to be construed restrictively. The image processing program according to the exemplary embodiments of the present invention can be also provided in such a way that the image processing program is recorded on a computer readable recording medium. For example, the image processing program according to the exemplary embodiments of the present invention may be provided in such a way that the image processing program is recorded on a compact disc (CD)-ROM, a digital versatile (DVD)-ROM, or a portable storage medium. Alternatively, the image processing program according to the exemplary embodiments of the present invention may be provided in such a way that the image processing program is recorded in a semiconductor memory, such as a flash memory.

The foregoing description of the exemplary embodiments of the present invention has been provided for the purposes of illustration and description. It is not intended to be exhaustive or to limit the invention to the precise forms disclosed. Obviously, many modifications and variations will be apparent to practitioners skilled in the art. The embodiments were chosen and described in order to best explain the principles of the invention and its practical applications, thereby enabling others skilled in the art to understand the invention for various embodiments and with the various modifications as are suited to the particular use contemplated. It is intended that the scope of the invention be defined by the following claims and their equivalents.

What is claimed is:

1. An image processing apparatus comprising:
an authenticating unit that performs authentication as to whether a user is an authenticated user who is permitted to use a plurality of functions;
a determining unit that, by use of history information that records an operation made by the authenticated user authenticated by the authenticating unit, determines an expected function that is expected to be executed by the authenticated user among the plurality of functions, and a setting attribute for each of setting items that specify how the expected function is to be executed;
a setting unit that sets the setting attribute for the expected function determined by the determining unit; and
a display that displays, on a display device, an execution screen that shows the setting attribute set by the setting unit and receives an instruction instructing that the expected function be executed.

2. The image processing apparatus according to claim 1,
wherein the determining unit determines, as the expected function, a function that is determined from a record of an operation made by the authenticated user before the authentication is started by the authenticating unit, and a record of an operation made by the authenticated user after the authentication.

3. The image processing apparatus according to claim 1,
wherein if an operation count indicating a number of times that an operation has been performed by the authenticated user before the authentication is started by the authenticating unit is less than a predetermined operation count, the determining unit determines, as the expected function, a function that is associated in advance with the operation that has been performed a number of times less than the predetermined operation count.

4. The image processing apparatus according to claim 1,
wherein the determining unit determines, as the expected function, a function that tends to be executed in accordance with an execution attribute corresponding to an execution attribute associated with the authenticated user at a time when the authentication is performed, among execution attributes corresponding to each of the plurality of functions that represent conditions under which the authenticated user has executed the plurality of functions.

5. The image processing apparatus according to claim 1,
wherein the determining unit determines, as the setting attribute for each setting item related to the expected function, a setting attribute that has been set a greater number of times than other setting attributes by the authenticated user before executing a function identical to the expected function.

6. The image processing apparatus according to claim 1,
wherein if a number of times that the authenticated user has displayed a setting screen used to set the setting attribute but has not changed the setting attribute is equal to or greater than a predetermined number of times, the display unit displays, on the execution screen, an area that receives an operation for setting the setting attribute that has not been changed.

7. The image processing apparatus according to claim 1, further comprising
an aggregating unit that aggregates a degree of prediction correctness for the expected function determined by the determining unit relative to a function actually executed by the authenticated user,
wherein if the degree of prediction correctness aggregated by the aggregating unit is less than a predetermined threshold, the determining unit determines, as the expected function, a function among the plurality of functions that has been executed more frequently than other functions by a plurality of authenticated users including the authenticated user.

8. A non-transitory computer readable medium storing a program causing a computer to execute a process for processing an image, the process comprising:
performing authentication as to whether a user is an authenticated user who is permitted to use a plurality of functions;
determining, by use of history information that records an operation made by the authenticated user, an expected function that is expected to be executed by the authenticated user among the plurality of functions, and a setting attribute for each of setting items that specify how the expected function is to be executed;
setting the setting attribute for the expected function that has been determined; and
displaying, on a display device, an execution screen that shows the setting attribute that has been set and receives an instruction instructing that the expected function be executed.

9. An image processing method comprising:
performing authentication as to whether a user is an authenticated user who is permitted to use a plurality of functions;
determining, by use of history information that records an operation made by the authenticated user, an expected function that is expected to be executed by the authenticated user among the plurality of functions, and a setting attribute for each of setting items that specify how the expected function is to be executed;
setting the setting attribute for the expected function that has been determined; and
displaying, on a display device, an execution screen that shows the setting attribute that has been set and receives an instruction instructing that the expected function be executed.
